(19) United States
(12) Patent Application Publication
(10) Pub. No.: US 2009/0058296 A1
(43) Pub. Date: Mar. 5, 2009

(54) PLASMA DISPLAY PANEL

(75) Inventors: Eiichi Uriu, Osaka (JP); Hatsumi Komaki, Osaka (JP); Shingo Takagi, Osaka (JP); Akira Kawase, Osaka (JP); Tatsuo Mifune, Osaka (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka, JP (JP)

(21) Appl. No.: 11/911,175

(22) PCT Filed: Feb. 26, 2007
(86) PCT No.: PCT/JP2007/053474

§ 371 Date: Oct. 10, 2007

(30) Foreign Application Priority Data
Feb. 28, 2006 (JP) 2006-051738

(51) Int. Cl. H01J 17/49

(52) U.S. Cl. 313/582

(57) ABSTRACT

The PDP has front panel (2), and a back panel with address electrodes formed thereon. Front panel (2) has display electrodes (6) including first electrodes (42b, 52b) and second electrodes (41b, 51b) formed on front glass substrate (3); and dielectric layer (8) covering display electrodes (6). Further, first electrodes (42b, 52b) and dielectric layer (8) include glass frit, which contains at least one of molybdenum oxide, magnesium oxide and cerium oxide; and bismuth oxide, with a softening point exceeding 550° C. The above-described makeup suppresses a coloring phenomenon in dielectric layer (8) and front glass substrate (3), thereby implementing a plasma display panel with a high luminance.

### TECHNICAL FIELD

The present invention relates to a plasma display panel used for a display device and the like.

### BACKGROUND ART

A plasma display panel (referred to as PDP hereinafter), with its possibility of finer resolution and larger screen size, is used to commercialize such as a 65-inch class television set. In recent years, a PDP has been applied to so-called “full-spec” high-definition TV, with the number of scanning lines twice that of a display device with conventional NTSC method. In addition, a lead-free PDP is demanded to deal with environmental issues.

A PDP is basically composed of a front panel and a back panel. The front panel has a glass substrate made of sodium borosilicate based glass produced by float process. The front panel further has display electrodes, a dielectric layer, and a protective layer, each formed on one main surface of the glass substrate. A display electrode is composed of striped transparent electrodes and bus electrodes. The dielectric layer, covering the display electrodes, works as a capacitor. The protective layer, made of magnesium oxide (MgO), is formed on the dielectric layer. A bus electrode is composed of a first electrode for reducing the connection resistance and a second electrode for blocking light.

The back panel has a glass substrate; and address electrodes, a base dielectric layer, barrier ribs, and a phosphor layer, each formed on one main surface of the glass substrate. The address electrodes are striped. The base dielectric layer covers the address electrodes. The barrier ribs are formed on the base dielectric layer. The phosphor layer, formed between respective barrier ribs, is composed of red, green, and blue phosphor layers, emitting red, green, and blue light, respectively.

The front panel and back panel are arranged so that the surfaces with the electrodes formed thereon mutually face, and airtight sealed. Further, an Ne—Xe discharge gas is encapsulated in a discharge space partitioned by the barrier ribs, at a pressure of 400 Torr to 600 Torr.

The PDP discharges with an image signal voltage selectively applied to some display electrodes. Ultraviolet light generated with discharge excites each color phosphor layer. Consequently, the PDP emits red, green, and blue light to display a color image.

A bus electrode contains silver to ensure conductivity. The dielectric layer conventionally contains glass frit with a low melting point containing lead oxide as the principal component. However, a PDP containing lead-free glass frit to deal with environmental issues of recent years is disclosed in such as Japanese Patent Unexamined Publication No. 2003-128430 (patent literature 1), No. 2002-053342 (patent literature 2), and No. H09-050769 (patent literature 3).

For glass frit used when forming bus electrodes, a PDP containing bismuth oxide instead of lead is disclosed in such as Japanese Patent Unexamined Publication No. 2000-048645 (patent literature 4).

[Patent literature 1] Japanese Patent Unexamined Publication No. 2003-128430
[Patent literature 2] Japanese Patent Unexamined Publication No. 2002-053342
[Patent literature 3] Japanese Patent Unexamined Publication No. H09-050769
[Patent literature 4] Japanese Patent Unexamined Publication No. 2000-048645

### SUMMARY OF THE INVENTION

The present invention provides a PDP with a coloring phenomenon in the dielectric layer and the substrate being suppressed and with a high luminance.

A PDP of the present invention has a front panel, and a back panel with address electrodes formed thereon. The front panel has display electrodes having first and second electrodes formed on the front glass substrate, and a dielectric layer covering the display electrodes. Further, the first and second electrodes include glass frit, which contains at least one of molybdenum oxide, magnesium oxide and cerium oxide; and bismuth oxide, with a softening point exceeding 550° C. The above-described makeup implements a PDP with a coloring phenomenon in the dielectric layer and the substrate being suppressed and with a high luminance.

### BRIEF DESCRIPTION OF DRAWINGS

FIG. 1 is a perspective view illustrating the structure of a PDP according to an embodiment of the present invention.

FIG. 2 is a sectional view illustrating the makeup of the front panel used for the PDP shown in FIG. 1.

FIG. 3 is a flowchart illustrating a method of manufacturing the PDP shown in FIG. 1.

FIG. 4 is a flowchart illustrating a part of the method of manufacturing the PDP shown in FIG. 1.

### REFERENCE MARKS IN THE DRAWINGS

1 PDP
2 Front panel
3 Front glass substrate
4 Scan electrode
4a, 5a Transparent electrode
4b, 5b Bus electrode
5 Sustain electrode
6 Display electrode
7 Black stripe
8 Dielectric layer
9 Protective layer
10 Back panel
11 Back glass substrate
12 Address electrode
13 Base dielectric layer
14 Barrier rib
15 Phosphor layer
16 Discharge space
41b, 51b Second electrode
42b, 52b First electrode
81 First dielectric layer
82 Second dielectric layer

### DETAILED DESCRIPTION OF PREFERRED EMBODIMENT

Hereinafter, a description is made for a PDP according to an embodiment of the present invention, using the related drawings.

### Exemplary Embodiment

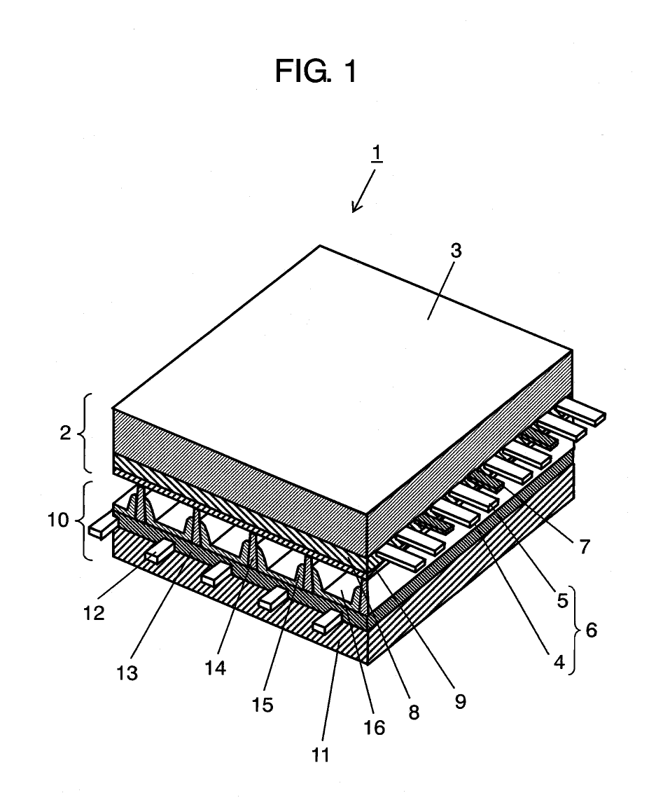

FIG. 1 is a perspective view illustrating the structure of a PDP according to an embodiment of the present invention. The basic structure of the PDP is of general AC surface-discharge type. As shown in FIG. 1, plasma display panel 1 (referred to as PDP 1 hereinafter) has front panel 2 and back panel 10 facing each other, where the outer circumferences of front panel 2 and back panel 10 are airtight sealed with a sealant (not shown) made of glass frit or the like. This structure forms discharge space 16 inside PDP 1. Further, a discharge gas such as Ne or Xe is encapsulated in discharge space 16 at a pressure of 400 Torr to 600 Torr.

Front panel 2 has front glass substrate 3; and display electrodes 6, black stripe 7 as a light blocking layer, dielectric layer 8, and protective layer 9, each formed on front glass substrate 3. Display electrodes 6 are strip-shaped with each pair of scan electrode 4 and sustain electrode 5 arranged parallel to each other. Further, plural series of display electrodes 6 and black stripe 7 are respectively arranged parallel to each other. Dielectric layer 8 is formed so as to cover display electrodes 6 and black stripe 7 to work as a capacitor. Protective layer 9, made of magnesium oxide (MgO) or the like, is formed on the surface of dielectric layer 8.

Back panel 10 has back glass substrate 11; and address electrodes 12, base dielectric layer 13, barrier ribs 14, and phosphor layer 15, each formed on back glass substrate 11. Plural strip-shaped address electrodes 12 are formed orthogonally to scan electrodes 4 and sustain electrodes 5, and arranged parallel to each other. Base dielectric layer 13 covers address electrodes 12. Barrier ribs 14, having a given height, are formed on base dielectric layer 13 between address electrodes 12 to partition discharge space 16. Phosphor layer 15 is formed in the grooves between barrier ribs 14 corresponding to each address electrode 12. Phosphor layer 15 is formed by sequentially applying phosphor layers respectively emitting red, blue, or green light, caused by ultraviolet light. A discharge cell is formed where scan electrode 4, sustain electrode 5, and address electrode 12 cross. A discharge cell having phosphor layers 15 for red, blue, and green, arranged in the direction of display electrodes 6 becomes a pixel for color display.

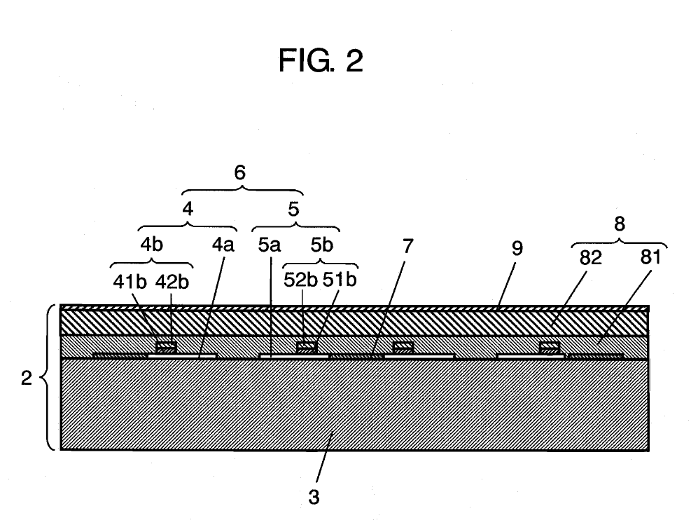

FIG. 2 is a sectional view illustrating the structure of front panel 2 used for PDP 1 shown in FIG. 1. FIG. 2 shows the image of FIG. 1 vertically inverted. As shown in FIG. 2, front glass substrate 3, produced by float process or the like, has display electrodes 6 and black stripe 7 pattern-formed thereon.

Scan electrode 4 and sustain electrode 5 are composed of transparent electrode 4a, 5a; and bus electrode 4b, 5b formed on transparent electrode 4a, 5a, respectively. Transparent electrodes 4a, 5a are made of material such as indium oxide (ITO) or tin oxide (SnO₂). Bus electrode 4b, 5b is formed to exert conductivity in the longitudinal direction of transparent electrode 4a, 5a, composed of white first electrode 42b, 52b for reducing the electrical resistance; and black second electrode 41b, 51b for blocking outside light, respectively.

Dielectric layer 8 is provided so as to cover transparent electrodes 4a, 5a, bus electrodes 4b, 5b, and black stripe 7. Further, dielectric layer 8 has at least two layers (i.e. first dielectric layer 81, and second dielectric layer 82 formed on first dielectric layer 81). Second dielectric layer 82 has protective layer 9 formed thereon.

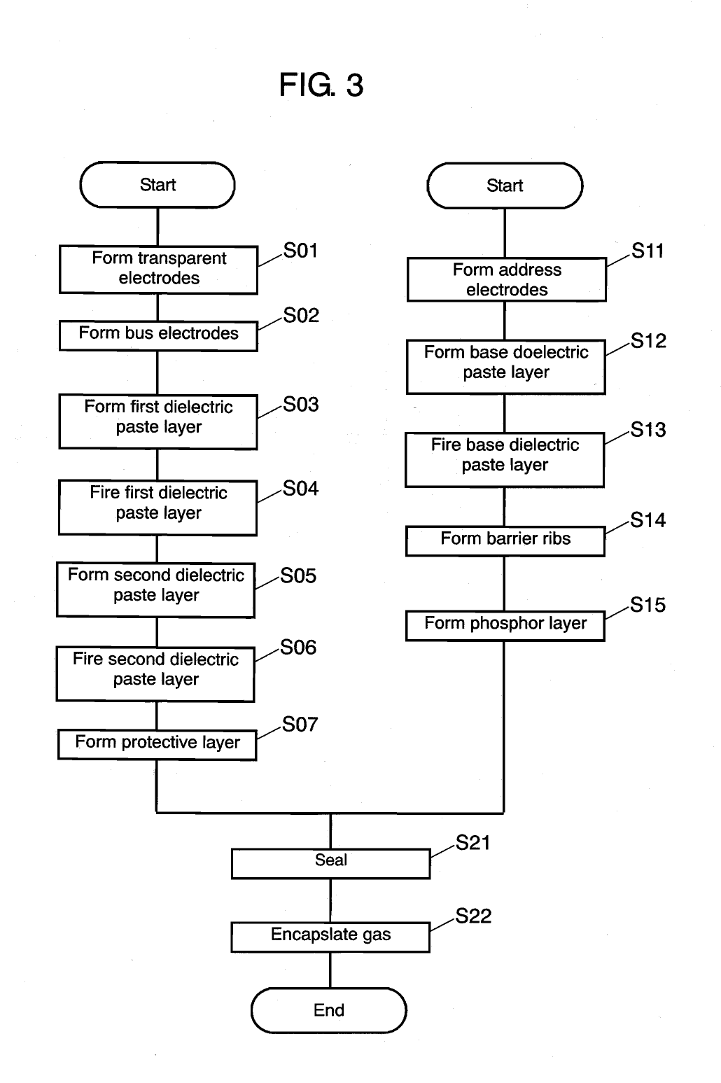

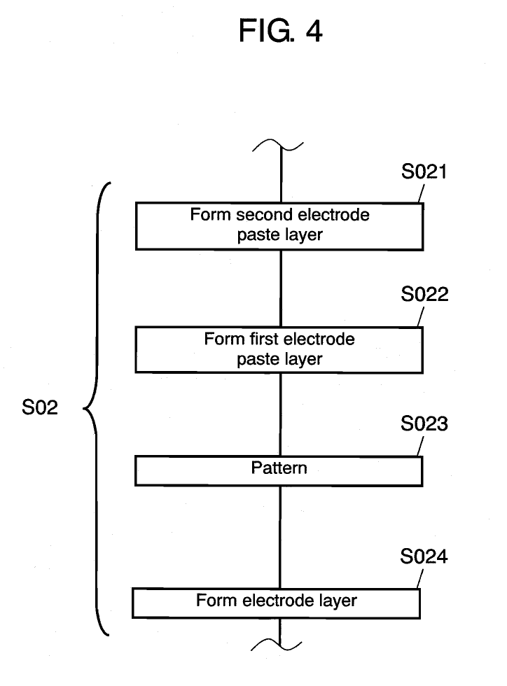

Next, a description is made for a method of manufacturing PDP 1, using FIGS. 3, 4.

FIG. 3 is a flowchart illustrating a method of manufacturing the PDP shown in FIG. 1. FIG. 4 is a flowchart illustrating the details about the bus electrode forming step of the method of manufacturing the PDP shown in FIG. 1.

Front panel 2 is produced in the following steps. First, scan electrodes 4, sustain electrodes 5, and black stripe 7 are formed on front glass substrate 3. Transparent electrodes 4a, 5a and bus electrodes 4b, 5b are formed by patterning using photolithography or the like.

More specifically, a transparent, conductive thin film of such as indium oxide (ITO) or tin oxide (SnO₂) is formed using thin film processing or the like. Patterning the transparent, conductive thin film formed on front glass substrate 3 by photolithography forms transparent electrode 4a, 5a partially composing scan electrode 4 and sustain electrode 5 (S01: transparent electrode forming step).

Next, a paste layer to be black stripe 7 and that to be bus electrodes 4b, 5b are film-formed by screen printing or the like, and then patterned by photolithography or the like to be formed. Here, a paste layer to be bus electrodes 4b, 5b is formed on transparent electrodes 4a, 5a. A paste layer to be bus electrodes 4b, 5b includes a first electrode paste layer containing silver material; and a second electrode paste layer containing conductive black particles. A paste layer to be black stripe 7 is as well made of paste material containing black pigment. Further, the paste layer to be black stripe 7 and that to be bus electrode 4b, 5b are fired at a desired temperature to be solidified (S02: bus electrode forming step). Undergoing the transparent electrode forming step (S01) and the bus electrode forming step (S02) forms scan electrodes 4, sustain electrodes 5, and black stripe 7.

Next, the first dielectric paste is applied by die coating so as to cover scan electrodes 4, sustain electrodes 5, and black stripe 7, thereby forming a first dielectric paste layer to be first dielectric layer 81 (S03: first dielectric paste layer forming step). Further, as a result that the first dielectric paste layer is left standing for a given time after the first dielectric paste is applied, the applied surface of the first dielectric paste layer is leveled to become flat. Here, the first dielectric paste is coating material containing powdered first dielectric glass frit, a binder, and solvent.

Next, the first dielectric paste layer is fired and solidified to form first dielectric layer 81 (S04: first dielectric paste layer firing step).

Next, a second dielectric paste layer to be second dielectric layer 82 is formed by applying the second dielectric paste by die coating so as to cover the first dielectric paste layer (S05: second dielectric paste layer forming step). Further, as a result that the second dielectric paste layer is left standing for a given time after the second dielectric paste is applied, the applied surface of the second dielectric paste layer is leveled to become flat. Here, the second dielectric paste is coating material containing powdered second dielectric glass frit, a binder, and solvent.

Next, the second dielectric paste layer is fired and solidified to form second dielectric layer 82 (S06: second dielectric paste layer firing step). As described above, undergoing the first dielectric paste layer forming step (S03), first dielectric paste layer firing step (S04), second dielectric paste layer forming step (S05), and second dielectric paste layer firing step (S06) forms dielectric layer 8 covering scan electrodes 4, sustain electrodes 5, and black stripe 7.

Next, protective layer 9 made of magnesium oxide is formed on dielectric layer 8 by vacuum evaporation method (S07: protective layer forming step).

Undergoing each step described above forms predetermined constructional elements on front glass substrate 3 to produce front panel 2.

Meanwhile, back panel 10 is produced in the following steps. First, address electrodes 12 are formed on back glass substrate 11 (S11: address electrode forming step). Here, address electrodes 12 are formed as a result that a material layer to be address electrodes 12 is formed on back glass substrate 11, and that the material layer formed is fired at a given temperature. The material layer to be address electrodes 12 is formed by a method such as where a paste containing silver material is screen-printed, or patterned by photolithography after a metal film is formed on the whole surface of back glass substrate 11.

Next, a base dielectric paste is applied by die coating or the like so as to cover address electrodes 12 to form a base dielectric paste layer to be base dielectric layer 13 (S12: base dielectric paste layer forming step). Here, as a result that the dielectric paste layer is left standing for a given time after the base dielectric paste is applied, the applied surface of the dielectric paste layer is leveled to become flat. The base dielectric paste is coating material containing powdered dielectric glass frit, a binder, and solvent.

Next, firing the base dielectric paste layer forms base dielectric layer 13 (S13: base dielectric paste layer firing step).

Next, a barrier rib forming paste containing barrier rib material is applied on base dielectric layer 13, and patterned into a given shape to form a barrier rib material layer. After that, firing the barrier rib material layer forms barrier ribs 14 (S14: barrier rib forming step). Here, a method such as photolithography or sandblasting is used to pattern the barrier rib forming paste applied on base dielectric layer 13.

Next, a phosphor paste containing phosphor material is applied on base dielectric layer 13 between adjacent barrier ribs 14 and on the sides of barrier ribs 14. Then, firing the phosphor paste forms phosphor layer 15 (S15: phosphor layer forming step).

Undergoing each step described above produces back panel 10 with given constructional elements formed on back glass substrate 11.

As described above, front panel 2 and back panel 10, respectively produced, are arranged facing each other so that display electrodes 6 and address electrodes 12 are orthogonalized, and the peripheries of front panel 2 and back panel 10 are sealed with a sealant (S21: seal step). Consequently, discharge space 16 partitioned by barrier ribs 14 is formed in the space between front panel 2 and back panel 10 mutually facing.

Next, encapsulating a discharge gas containing a noble gas such as neon or xenon in discharge space 16 produces PDP 1 (S22: gas encapsulating step).

Next, further details are described about display electrodes 6 and dielectric layer 8, both provided on front panel 2.

Display electrode 6 is formed by sequentially laminating transparent electrode 4a, 6a; second electrode 41b, 51b; and first electrode 42b, 52b, on front glass substrate 3. First, after indium oxide with a thickness of approximately 0.12 μm is formed on the whole surface of front glass substrate 3 by sputtering, transparent electrodes 4a, 5a, striped with a width of 150 μm, are formed by photolithography (S01: transparent electrode forming step).

Next, a second electrode paste to be second electrode 41b, 51b is applied on the whole surface of front glass substrate 3, by printing method or the like to form a second electrode paste layer (S021: second electrode paste layer forming step). Here, the second electrode paste layer becomes second electrodes 41b, 51b, and black stripe 7 by being patterned and fired.

The second electrode paste contains conductive black particles of 70 wt % to 90 wt %, second glass frit of 1 wt % to 15 wt %, and a photosensitive organic binder component of 8 wt % to 15 wt %. The conductive black particles are at least one kind of black metal microparticles selected from the group of Fe, Co, Ni, Mn, Ru, and Rh; or metal oxide microparticles containing these black metals. The photosensitive organic binder component contains photosensitive polymer, photosensitive monomer, a light polymerization initiator, solvent, and others. The second glass frit contains at least bismuth oxide (Bi₂O₃) of 20 wt % to 50 wt %. The second glass frit further contains at least one material out of molybdenum oxide (MoO₃), magnesium oxide (MgO), and cerium oxide (CeO₂). The second glass frit further has a softening point exceeding 550° C.

Here, a paste layer to be black stripe 7 may be formed with material different from that of the second electrode paste layer to be second electrodes 41b, 51b, and by a different method. However, using the second electrode paste layer as a paste layer to be black stripe 7 dispenses with the step of independently providing black stripe 7, thereby improving the production efficiency.

Next, the first electrode paste is applied on the second electrode paste layer by printing method or the like, to form a first electrode paste layer (S022: first electrode paste layer forming step).

Here, the first electrode paste contains at least silver particles of 70 wt % to 90 wt %, glass frit of 1 wt % to 15 wt %, and photosensitive organic binder component of 8 wt % to 15 wt %. The photosensitive organic binder component contains photosensitive polymer, photosensitive monomer, a light polymerization initiator, solvent, and others. The first glass frit contains at least bismuth oxide (Bi₂O₃) of 20 wt % to 50 wt %. The first glass frit further contains at least one material out of molybdenum oxide (MoO₃), magnesium oxide (MgO), and cerium oxide (CeO₂). The first glass frit further has a softening point exceeding 550° C.

Next, the second and first electrode paste layers applied on the whole surface of front glass substrate 3 are patterned by photolithography or the like (S023: patterning step).

Firing the second and first electrode paste layers after being patterned, at 550° C. to 600° C. produces second electrodes 41b, 51b and first electrodes 42b, 52b with a line width of approximately 60 μm, on transparent electrodes 4a, 5a (S024: electrode layer firing step). In the same way, black stripe 7 is formed by being fired as well in the electrode layer firing step (S024).

Here, the first glass frit used for first electrodes 42b, 52b and the second glass frit used for second electrodes 41b, 51b contain bismuth oxide (Bi₂O₃) of 20 wt % to 50 wt %. The first and second glass frits are glass material containing, in addition to bismuth oxide, boron oxide (B₂O₃) of 15 wt % to 35 wt %, silicon oxide (SiO₂) of 2 wt % to 15 wt %, aluminium oxide (Al₂O₃) of 0.3 wt % to 4.4 wt %, and others. The first and second glass frits further contain at least one material out of molybdenum oxide (MoO₃), magnesium oxide (MgO), and cerium oxide (CeO₂). Here, the first and second glass frits may have the same material composition with completely the same composition ratio or with a different ratio.

In a conventional PDP, glass frit with a low softening point (450° C. to 550° C.) is used, where the firing temperature is 550° C. to 600° C. That is, the firing temperature is approximately 100° C. higher than the softening point of the glass frit. Accordingly, the bismuth oxide itself, with a high reactivity, contained in the glass frit reacts vigorously with silver and black metal microparticles, or with an organic binder component contained in the paste, to generate bubbles in bus electrodes 4b, 5b and dielectric layer 8, thereby deteriorating the dielectric strength of dielectric layer 8 in some cases.

However, for PDP 1 of the present invention, the softening point of the first and second glass frits exceeds 550° C., and the firing temperature is 550° C. to 600° C. That is, the softening point of the first and second glass frits is close to the firing temperature, thus depressing the reaction of silver and black metal microparticles or an organic component, with bismuth oxide. This decreases bubbles occurring in bus electrodes 4b, 5b and dielectric layer 8. Here, a softening point of the glass frit higher than 600° C. tends to depress the adhesiveness of bus electrodes 4b, 5b, transparent electrodes 4a, 5a, front glass substrate 3, and dielectric layer 8. Accordingly, the softening point of the first and second glass frits is preferably higher than 550° C. and lower than 600° C.

Next, a detailed description is made for first dielectric layer 81 and second dielectric layer 82 composing dielectric layer 8 of front panel 2.

First, a first dielectric paste is applied on front glass substrate 3 by die coating or screen printing so as to cover the second and first electrode paste layers. The first dielectric paste, after being applied, is dried and fired to form a first dielectric paste layer (S03: first dielectric paste layer forming step).

The first dielectric glass material contained in first dielectric layer 81 is composed in the following material composition. That is, the first dielectric glass material contains bismuth oxide (Bi₂O₃) of 25 wt % to 40 wt %, zinc oxide of 27.5 wt % to 34 wt %, boron oxide (B₂O₃) of 17 wt % to 36 wt %, silicon oxide (SiO₂) of 1.4 wt % to 4.2 wt %, aluminium oxide (Al₂O₃) of 0.5 wt % to 4.4 wt %. The first dielectric glass material further contains at least one kind of material of 5 wt % to 13 wt % selected from calcium oxide (CaO), strontium oxide (SrO), and barium oxide (BaO). The first dielectric glass material still further contains at least one kind of material of 0.1 wt % to 7 wt % selected from molybdenum oxide (MoO₃) and tungsten oxide (WO₃). The first dielectric glass material may contain, instead of molybdenum oxide (MoO₃) and tungsten oxide (WO₃), at least one kind of material of 0.1 wt % to 7 wt % selected from cerium oxide (CeO₂), copper oxide (CuO), manganese dioxide (MnO₂), chromium oxide (Cr₂O₃), cobalt oxide (CO₂O₃), vanadium oxide (V₂O₇), and antimony oxide (Sb₂O₃).

The first dielectric glass material with the composition is crushed so as to be 0.5 μm to 2.5 μm in average particle diameter using a wet jet mill or ball mill to produce first dielectric glass frit. Next, the first dielectric glass frit of 55 wt % to 70 wt % and a binder component of 30 wt % to 45 wt % are kneaded using a triple roll mill to produce a first dielectric paste for die coating or printing. Here, the binder component contained in the first dielectric paste is terpineol or butyl carbitol acetate, containing ethyl cellulose or acrylic resin of 1 wt % to 20 wt %. A plasticizer, dispersant, or the like may be added into the first dielectric paste as required to improve the print quality. A plasticizer to be added includes di-octyl phthalate, di-butyl phthalate, triphenyl phosphate, or tributyl phosphate, for example. A dispersant to be added includes glycerol monooleate, sorbitan sesquioleate, Homogenol (registered trademark of Kao Corporation), or alkylallylic phosphate ester, for example.

Next, the first dielectric layer paste layer is fired at 575° C. to 590° C., slightly higher than the softening point of the first dielectric glass frit (S04: first dielectric paste layer firing step). This process forms first dielectric layer 81 covering the second and first electrode paste layers and black stripe 7.

Next, a second dielectric paste is applied on the first dielectric paste layer by screen printing or die coating. The second dielectric paste, after being applied, is dried to form a second dielectric paste layer (S05: second dielectric paste layer forming step).

The second dielectric glass material contained in second dielectric layer 82 has the following material composition. That is, the second dielectric glass material contains bismuth oxide (Bi₂O₃) of 11 wt % to 20 wt %, zinc oxide (ZnO) of 26.1 wt % to 39.3 wt %, boron oxide (B₂O₃) of 23 wt % to 32.2 wt %, silicon oxide (SiO₂) of 1 wt % to 3.8 wt %, and aluminium oxide (Al₂O₃) of 0.1 wt % to 10.2 wt %. The second dielectric glass material further contains at least one kind of material of 9.7 wt % to 29.4 wt % selected from calcium oxide (CaO), strontium oxide (SrO), and barium oxide (BaO). The second dielectric glass material still further contains cerium oxide (CeO₂) of 0.1 wt % to 5 wt %.

The second dielectric glass material with the composition is crushed so as to be 0.5 μm to 2.5 μm in average particle diameter using a wet jet mill or ball mill to produce second dielectric glass frit. Next, the second dielectric glass frit of 55 wt % to 70 wt % and a binder component of 30 wt % to 45 wt % are kneaded using a triple roll mill to produce a second dielectric paste for die coating or printing. Here, the binder component contained in the second dielectric paste is terpineol or butyl carbitol acetate, containing ethyl cellulose or acrylic resin of 1 wt % to 20 wt %. A plasticizer, dispersant, or the like may be added into the second dielectric paste as required to improve the print quality. A plasticizer to be added includes di-octyl phthalate, di-butyl phthalate, triphenyl phosphate, or tributyl phosphate, for example. A dispersant to be added includes glycerol monooleate, sorbitan sesquioleate, Homogenol (registered trademark of Kao Corporation), or alkylallylic phosphate ester, for example.

Next, the second dielectric layer paste layer is fired at 550° C. to 590° C., slightly higher than the softening point of the second dielectric glass frit (S06: second dielectric paste layer firing step). This process forms second dielectric layer 82 covering first dielectric layer 81, and these layers form dielectric layer 8.

The film thickness of dielectric layer 8, including first dielectric layer 81 and second dielectric layer 82, is preferably smaller than 41 μm to ensure the transmittance of visible light. First dielectric layer 81 contains bismuth oxide of 25 wt % to 40 wt %, which is more than that contained in the second dielectric layer 82, to suppress the reaction with silver contained in bus electrodes 4b, 5b. Accordingly, the visible-light transmittance of first dielectric layer 81 is lower than that of second dielectric layer 82. The film thickness of first dielectric layer 81 is thus thinner than that of second dielectric layer 82, thereby ensuring the transmittance of visible light transmitting through dielectric layer 8.

Second dielectric layer 82 containing bismuth oxide of less than 11 wt % is resistant to a coloring phenomenon, while bubbles are subject to occurring in second dielectric layer 82. Meanwhile, if the percentage of bismuth oxide content exceeds 20 wt %, a coloring phenomenon tends to occur, making difficult to increase the transmittance. Consequently, the percentage of bismuth oxide content in the second dielectric paste is preferably 11 wt % to 20 wt %.

As the film thickness of dielectric layer 8 becomes thinner, the panel luminance is improved and the discharge voltage is decreased more prominently. Accordingly, the film thickness of dielectric layer 8 is desirably thinnest possible as long as the dielectric strength does not decrease. From such a viewpoint, the film thickness of dielectric layer 8 is set to 41 μm or thinner; first dielectric layer 81, 5 μm to 15 μm; and second dielectric layer 82, 20 μm to 36 μm, in the embodiment of the present invention.

As described above, PDP 1 is resistant to a coloring phenomenon such as yellowing in front glass substrate 3 even if silver material is used for display electrode 6. In addition, bubbles in dielectric layer 8 do not occur, thereby implementing dielectric layer 8 with high dielectric strength.

Next, in PDP 1 according to the present invention, consideration is made for reasons why a coloring phenomenon in front glass substrate 3 and in first dielectric layer 81, and bubbles occurring in first dielectric layer 81 are suppressed.

In a conventional PDP, high-definition TV needs the number of scanning lines to be increased, namely the number of display electrodes increases and their spacing decreases. Accordingly, more silver ions diffuse from silver electrodes composing display electrodes to the dielectric layer or glass substrate. Diffusion of silver ions (Ag⁺) to the dielectric layer or glass substrate causes the silver ions (Ag⁺) to undergo reduction due to alkali metal ions in the dielectric layer or divalent tin ions contained in the glass substrate. This effect generates colloidal silver, thereby yellowing or browning the dielectric layer or glass substrate.

In PDP 1 of the present invention, meanwhile, at least one material out of molybdenum oxide, magnesium oxide, and cerium oxide is added to the first and second glass frits. Reaction of these materials with silver ions (Ag⁺) generates a compound containing silver such as Ag₂MOO₄, Ag₂MO₂O₇, Ag₂MO₄O₁₃, AgMgO, or Ag₂CeO₃, at a low temperature of 580° C. or lower.

In the present invention, the firing temperature of dielectric layer 8 is 550° C. to 590° C. Consequently, silver ions (Ag⁺) diffusing in dielectric layer 8 react with molybdenum oxide, magnesium oxide, or cerium oxide, contained in first electrode 42b, 52b and second electrode 41b, 51b, while dielectric layer 8 is being fired, to generate a stable compound, thereby stabilizing the silver ions (Ag⁺). In other words, silver ions (Ag⁺) are stabilized without undergoing reduction. Accordingly, silver ions (Ag⁺) do not generate colloids due to aggregation of the silver ions (Ag⁺). Stabilized silver ions (Ag⁺) decrease oxygen occurring involved in colloidal silver, resulting in fewer bubbles generated in dielectric layer 8.

In dielectric layer 8 used for PDP 1 of the present invention, a coloring phenomenon and bubble occurrence are suppressed in first dielectric layer 81 contacting first electrode 42b, 52b containing silver material. Further, second dielectric layer 82 provided on first dielectric layer 81 implements a high transmittance of visible light. In addition, first glass frit used for first electrode 42b, 52b and second glass frit used for second electrode 41b, 51b contain at least bismuth oxide (Bi₂O₃) of 20 wt % to 50 wt %. The first and second glass frits further contain at least one material out of molybdenum oxide (MoO₃), magnesium oxide (MgO), and cerium oxide (CeO₂), and have a softening point exceeding 550° C., thus further suppressing bubbles occurring from bus electrode 4b, 5b. As a result, a coloring phenomenon such as yellowing of front glass substrate 3 is unlikely to occur, thus implementing PDP 1 with a high transmittance owing to extremely limited likelihood of the occurrence of bubbles and a coloring phenomenon in whole dielectric layer 8.

In PDP 1 of the present invention, when address electrodes 12 are formed on the back glass substrate 11, address electrodes 12 contain at least silver and third glass frit. Further, the third glass frit contains at least bismuth oxide (Bi₂O₃) and has a softening point exceeding 550° C. Consequently, in the same way as in the relationship between bus electrode 4b, 5b and dielectric layer 8, described above, bubbles occurring from address electrodes 12 are suppressed, thereby improving the dielectric strength of base dielectric layer 13. Consequently, the reliability of back panel 10 is improved.

A base dielectric paste to be base dielectric layer 13 preferably has material composition same as that of a first dielectric paste. That is, base dielectric glass frit contained in the base dielectric paste has material composition same as that of the first dielectric glass frit. Consequently, in the same way as in the relationship between bus electrode 4b, 5b and dielectric layer 8, described above, bubbles occurring from address electrodes 12 are further suppressed. Accordingly, a coloring phenomenon such as yellowing of second substrate 11 is unlikely to occur, thus implementing PDP 1 with extremely limited likelihood of the occurrence of bubbles and a coloring phenomenon in whole base dielectric layer 13. Consequently, the dielectric strength of base dielectric layer 13 is improved, and so is the reliability of back panel 10.

As described above, PDP 1 of the present invention has front panel 2 with a high transmittance of visible light and high dielectric strength, and has back panel 10 with high dielectric strength. Accordingly, PDP 1 is implemented with a high reliability and environmental friendliness owing to being free from a lead component.

### INDUSTRIAL APPLICABILITY

As described above, the present invention implements a PDP environmentally friendly and superior in display quality as a result that a coloring phenomenon and deterioration of the dielectric strength in the dielectric layer are suppressed, and thus the PDP is useful for a large-screen display device and the like.

1. A plasma display panel comprising:
a front panel including:
a display electrode including:
a first electrode formed on a front glass substrate, and containing silver; and
a second electrode formed under the first electrode;
a dielectric layer covering the display electrode; and
a back panel including an address electrode formed on a back glass substrate,
wherein a discharge space is formed by the front panel and the back panel arranged mutually facing,
wherein the first electrode and the second electrode include glass frit, which contains at least one of molybdenum oxide, magnesium oxide and cerium oxide, and bismuth oxide, with a softening point higher than 550° C.

2. The plasma display panel of claim 1,
wherein the glass frit contains the bismuth oxide of 20 wt % or higher and 50 wt % or lower.

3. The plasma display panel of claim 1,
wherein the address electrode contains at least silver and glass frit; and
wherein the glass frit contained in the address electrode contains at least bismuth oxide and has a softening point higher than 550° C.

4. The plasma display panel of claim 1,
wherein the dielectric layer contains at least bismuth oxide of 25 wt % or more and 40 wt % or less.

5. The plasma display panel of claim 2,
wherein the dielectric layer contains at least bismuth oxide of 25 wt % or more and 40 wt % or less.
